(19) United States
(12) Patent Application Publication
(10) Pub. No.: US 2012/0000123 A1
(43) Pub. Date: Jan. 5, 2012

(54) Pivoting plant support system

(76) Inventor: Michael Tavis Donaldson, Santa Rosa, CA (US)

(21) Appl. No.: 12/803,628

(22) Filed: Jun. 30, 2010

(51) Int. Cl. A01G 9/12

(52) U.S. Cl. 47/45; 47/44

(57) ABSTRACT

An apparatus for supporting foliage or fruit on plants and bushes includes a base ring assembly. The base ring assembly includes a plurality of base ring sections that are placed around a base of a plant and which snap together around the base, or stem, of the plant. A pivot assembly supports a lower rod that is able to pivot inward toward a line extending vertically upward from a center of the plant support system or to pivot outward away from the line. The lower rod is able to be secured in the desired position. At least one leg is attached to the base ring assembly for insertion into a soil or growing medium. A preferred oval or elliptical hollow center version of the lower rod is described along with an upper rod that are used to provide an extensible variable overall length structure.

### BACKGROUND OF THE INVENTION

1. Field of the Invention

The present invention, in general, relates to agriculture and, more particularly, to a system for supporting the growth of vegetation or fruit occurring on vegetable or flower plants, shrubs, and bushes.

The need to support plant growth is well known in the agricultural arts. However, prior art plant supports include numerous shortcomings that fail to adequately address the support needs of plants, shrubs and bushes.

For example, plants grow and therefore it is desirable to be able to extend outward the support that is provided as the foliage and fruit develop. In other words it is desirable to be able to change the overall shape of the structural members that provide support for the plant's foliage and fruit as the shape of the plant changes. Prior art devices are unable to adequately do so.

It is also desirable to be able to increase the carrying capacity provided by the support as the plant grows additional foliage and develops fruit.

Prior art devices, like tomato cages, also must be applied by inserting them down over the top of the tomato plant. This can damage the foliage of the plant and thereby lessen the tomato yield.

It is desirable to be able to install a plant support around a base of a plant without having to insert the device from the top down or otherwise damage the foliage.

Accordingly, there exists today a need for a plant support system that helps to ameliorate the above-mentioned problems and difficulties as well as ameliorate those additional problems and difficulties as may be recited in the “OBJECTS AND SUMMARY OF THE INVENTION” or discussed elsewhere in the specification or which may otherwise exist or occur and that are not specifically mentioned herein.

As various embodiments of the instant invention help provide a more elegant solution to the various problems and difficulties as mentioned herein, or which may otherwise exist or occur and are not specifically mentioned herein, and by a showing that a similar benefit is not available by mere reliance upon the teachings of relevant prior art, the instant invention attests to its novelty. Therefore, by helping to provide a more elegant solution to various needs, some of which may be long-standing in nature, the instant invention further attests that the elements thereof, in combination as claimed, cannot be obvious in light of the teachings of the prior art to a person of ordinary creativity.

Clearly, such system would be useful and especially desirable.

2. Description of Prior Art

Plant supports are, in general, known. For example, the following patent documents describe various types of these devices, some of which may have some degree of relevance to the invention. Other patent documents listed below may not have any significant relevance to the invention. The inclusion of these patent documents is not an admission that their teachings anticipate any aspect of the invention. Rather, their inclusion is intended to present a broad and diversified understanding regarding the current state of the art appertaining to either the field of the invention or possibly to other related or even distal fields of invention.

U.S. Pat. No. 7,637,055 to Donaldson, that issued on Dec. 29, 2009;

U.S. Pat. No. 6,299,125 to Zayeratabat, that issued on Oct. 9, 2001;

U.S. Pat. No. 6,209,258 to Schneider, that issued on Apr. 3, 2001;

U.S. Pat. No. 5,870,854 to Wilkins, that issued on Feb. 16, 1999;

U.S. Pat. No. 5,778,597 to Klevstad, that issued on Jul. 14, 1998;

U.S. Pat. No. 5,711,107 to Louisiana, that issued on Jan. 27, 1998;

U.S. Pat. No. 5,542,209 to Sheu, that issued on Aug. 6, 1996;

U.S. Pat. No. 5,473,839 to Stidham, that issued on Dec. 12, 1995;

U.S. Pat. No. 5,349,780 to Dyke, that issued on Sep. 27, 1994;

U.S. Pat. No. 5,327,678 to Schweiker, that issued on Jul. 12, 1994;

U.S. Pat. No. 5,282,335 to Holtkamp, Jr., that issued on Feb. 1, 1994;

U.S. Pat. No. 3,165,863 to Duran, that issued on Jan. 19, 1965;

U.S. Pat. No. 3,136,510 to Bowers, et al., that issued on

### Jun. 9, 1964;

U.S. Pat. No. 2,244,995 to Klaassen, that issued on Jun. 10, 1941;

U.S. Pat. No. 2,083,678 to Wilson, that issued on Jun. 15, 1937;

U.S. Pat. No. 2,083,526 to Rinker, that issued on Jun. 8, 1937;

U.S. Pat. No. 2,011,990 to Aldridge, that issued on Aug. 20, 1935;

U.S. Pat. No. 1,771,207 to Coscioni, that issued on Jul. 22, 1930;

U.S. Pat. No. 1,536,678 to Markowski, that issued on May 5, 1925; and

U.S. Pat. No. 548,508 to Bjelland, that issued on Oct. 22, 1895;

and including U.S. patent application Publication:

U.S. Patent Application Publication No. 2005/0044786 to Mastronardi, that published on Mar. 3, 2005.

While the structural arrangements of the above described devices may, at first appearance, have similarities with the present invention, they differ in material respects. These differences, which will be described in more detail hereinafter, are essential for the effective use of the invention and which admit of the advantages that are not available with the prior devices.

### OBJECTS AND SUMMARY OF THE INVENTION

It is an object of the present invention to provide a plant support system that is inexpensive to manufacture.

It is also an important object of the invention to provide a plant support system that can be assembled around a base of a plant, thereby helping to prevent damage from occurring to the plant.

Another object of the invention is to provide a plant support system that can be installed over existing plants with considerable foliage or fruit without causing damage to any of the foliage or fruit.

Still another object of the invention is to provide a plant support system that includes a base ring assembly that includes at least two base ring sections that snap together to form the base ring assembly.

Still yet another object of the invention is to provide a plant support system that includes at least one upright support for securing plant foliage or fruit thereto that is pivotable with respect to a line extending vertically upward from a center of the plant support system.

Yet another important object of the invention is to provide a plant support system that includes a lower rod and an upper rod that cooperate with each other to provide a desired combined overall length.

Still yet another important object of the invention is to provide a plant support system that includes at least one clip which is useful for securing an irrigation drip line thereto.

A first continuing object of the invention is to provide a plant support system that includes a lower rod that is able to pivot inward or outward with respect to a line extending vertically upward from a center of the plant support system, and thereby provide additional support and carrying capacity for increasing foliage and developing fruit.

A second continuing object of the invention is to provide a plant support system that can be expanded to provide additional carrying capacity by adding additional support structures to the existing plant support system without having to remove the plant support system or any part of the plant support system.

Briefly, a plant support system that is constructed in accordance with the principles of the present invention has a base ring assembly that includes a plurality of base ring sections that are placed around a base of a plant and which snap together around the base or stem of the plant. A pivot assembly supports a lower rod that is able to pivot inward toward a line extending vertically upward from a center of the plant support system or to pivot outward away from the line. The lower rod is able to be secured in the desired position. At least one leg is attached to the base ring assembly for insertion into a soil or growing medium. A preferred oval or elliptical hollow center version of the lower rod is described along with an upper rod that is used to provide an extensible variable overall length structure.

### BRIEF DESCRIPTION OF THE DRAWINGS

FIG. 1 is a view in perspective of a plant support system.

FIG. 2 is an enlarged exploded view in perspective of a pivot assembly of the plant support system of FIG. 1.

FIG. 3 is an enlarged exploded view in perspective of a latch assembly that is used to secure adjoining base ring sections of the plant support system of FIG. 1 together.

FIG. 4 is a view in perspective of a leg of the plant support system of FIG. 1 taken from the bottom of FIG. 1.

FIG. 5 is an exploded view in perspective of a preferred lower rod and upper rod of the plant support system of FIG. 1.

FIG. 6 is a cross sectional view taken on the line 6-6 in FIG. 4.

### DETAILED DESCRIPTION OF THE INVENTION

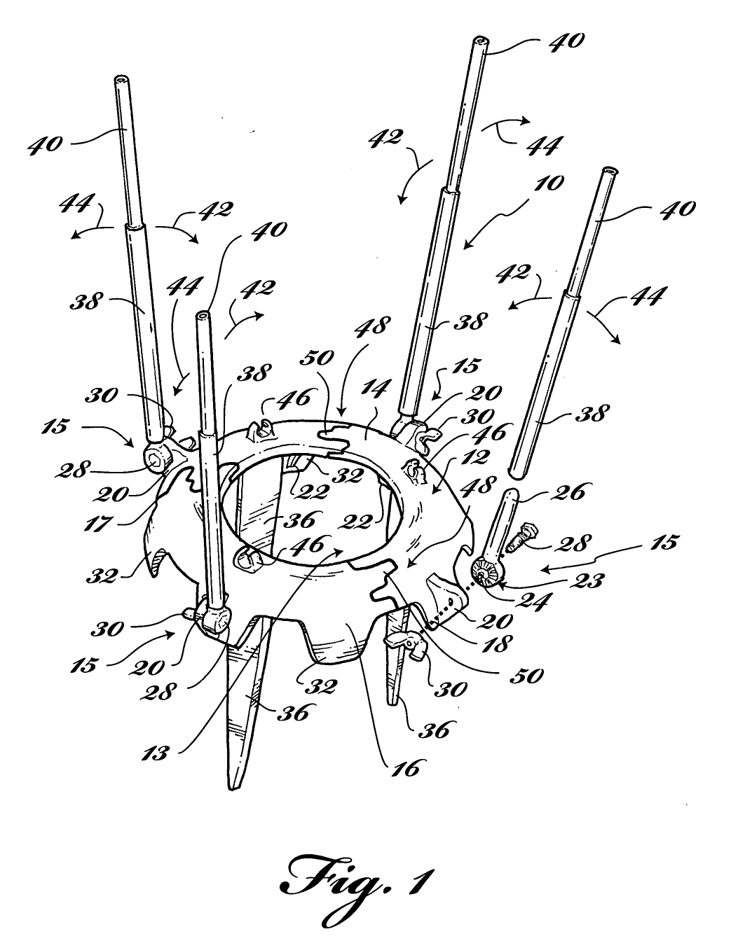

Referring on occasion to all of the FIGURE drawings and now, in particular to FIG. 1, is shown a plant support system, identified in general, by the reference numeral 10.

The reader will notice that reference is occasionally made throughout the DETAILED DESCRIPTION OF THE INVENTION suggesting that the reader refer to a particular drawing FIGURE. The suggestion is at times made when the introduction of a new element requires the reader to refer to a different drawing FIGURE than the one currently being viewed and also when the timely viewing of another drawing FIGURE is believed to significantly improve ease of reading or enhance understanding. To promote rapid understanding of the instant invention the reader is encouraged to periodically refer to and review each of the drawing FIGURES for possible cross-referencing of component parts and for other potentially useful information.

The plant support system 10 includes a base ring assembly, identified in general by the reference numeral 12, that extends in a circle. The base ring assembly 12 includes a predetermined outside diameter and a predetermined inside diameter and resembles, in general, a ring with an open center.

As such, the base ring assembly 12 includes an inner opening, identified in general by the reference numeral 13. During use, the inner opening 13 surrounds a plant (not shown) that is growing in soil or in any other preferred (root) growing medium. Installation and use of the plant support system 10 is described in greater detail, hereinafter. The plant support system 10 is also especially well suited for hydroponics.

The base ring assembly 12 can include any desired outside or inside diameter. It can also include any preferred shape. While a circular ring-like shape is generally preferred any shape is possible for the base ring assembly 12, including square, oval, or rectangular shapes, when viewed from the top. The circular shape is expected to be the most popular as the plant support system 10 is anticipated to be used with a wide variety of plants and shrubs that are grown in various sized circular pots, as is well known in the agriculture, gardening, and floral arts.

Square and rectangular pots and planter boxes also exist and the plant support system 10 can be adapted for use with any shape or size of a pot or a planter. In addition to varying the shape of the base ring assembly 12, the scale can also be varied to provide increased support for larger plants and shrubs. Similarly, the number of certain components can be increased or decreased, as desired. For example, if the plant support system 10 is modified for use in a rectangular shaped planter box in addition to providing a rectangular shaped base ring assembly 12 it is also possible to include as many pivot assemblies, identified in general by the reference numeral 15, as is desired. The pivot assembly 15 is described in greater detail, hereinafter.

The base ring assembly 12, as well as any other component part of the plant support system 10, can be formed of any desired material, including plastics, metals, fiberglass, composite, and other types of materials. While plastic is a preferred material for many component parts of the plant support system 10, the use of a treated plastic that includes an additive to accelerate decomposition and thereby make the plant support system 10 bio-degradable is especially preferred for reasons based largely on prudent environmental responsibility. The use of such additives is known and additional additives are currently being formulated. It is anticipated that the plant support system 10 will include, whenever possible and desirable, any available additive(s) or specific type of plastic that helps make the plastic it is formed of (when it is formed of a plastic) more easily or readily bio-degradable.

If desired, the base ring assembly 12 can be formed (i.e., molded) as a single piece and then slipped over the top of a small plant during installation. However, a preferred construction for the base ring assembly 12 is for it to be formed of two or more sections that are joined together by the consumer (i.e., by a user) at the time of installation.

This provides several significant advantages and unexpected benefits. First, it allows for less complex mold forms which are less expensive to manufacture and easier to use. Accordingly, the plant support system 10 is less expensive to produce. Second, it allows for installation of the base ring assembly 12 around a base of a plant (not shown) in sections. This, in turn, prevents damage to the foliage of the plant that could otherwise occur if a solid (i.e., one-piece) base ring assembly (not shown) was urged down over a larger plant from the top down.

As such, the plant support system 10 can be installed over larger plants, including established plants and shrubs that, by their size, would preclude installation (i.e., placement) of a one-piece base ring assembly over the top of the plant or shrub. This provides an unexpected benefit when compared to currently known plant support devices that are not suited for installation and use with larger or established plants because they cannot be installed over plants (or shrubs) that have already developed sufficient branch (foliage) growth. Yet it is when such growth has already occurred that the need for additional plant support is often realized.

For example, a homeowner or plant hobbyist (i.e., the user) may, at the time of planting a tomato plant, install a small tomato cage or nothing at all around the tiny plant. Later, as the plant grows and begins to bear fruit the user may wish to add additional plant support to the burgeoning plant. With prior art plant supports the user would be unable to do so. When using the plant support system 10 that includes a sectional base ring assembly 12, it can be installed around the plant regardless of the size of the plant and the amount of growth (i.e., branches, foliage, fruit, etc.) that the plant already has. This can prevent the loss of considerable fruit and foliage and is, therefore, an important and unexpected benefit provided by the instant invention.

Additionally, the smaller pieces of the sectional base ring assembly 12 allows the plant support system 10 to be packaged into a much smaller shipping container which, in turn, provides a greater inventory quantity in a given volume and a decreases the area required for retail display of the plant support system 10.

As shown the base ring assembly 12 includes three base ring sections 14, 16, 17 that snap together to form the base ring assembly 12. It is possible to include two or more than three of the base ring sections 14, 16, 17, if desired. For most applications it is generally preferred to include the three base ring sections 14, 16, 17 with each of the base ring sections 14, 16, 17 including one of three legs 36. Of course, any number of legs 36 can also be included with the plant support system 10. It is generally desirable (for most versions of the plant support system 10) to include only one of the legs 36 with each base ring section 14, 16, 17 to minimize bulk, as previously mentioned', for packaging concerns.

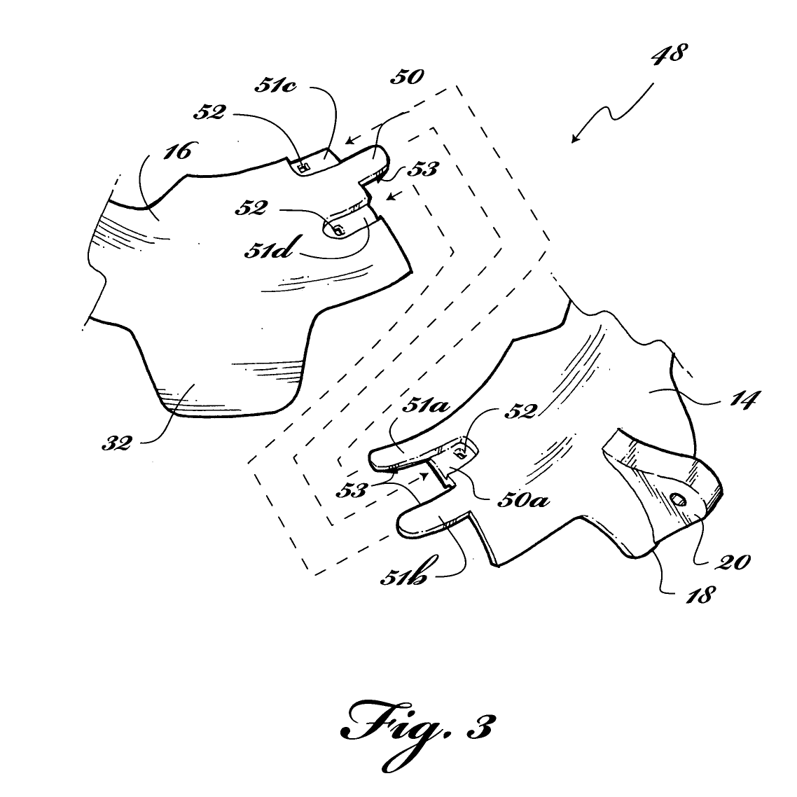

Referring now to FIG. 3, is shown how base ring sections 14 and 16 are joined together, which is the same way that base ring sections 14 and 17 are joined together and that base ring sections 17 and 16 are joined together. A latch assembly, identified in general by the reference numeral 48, allows the user to quickly secure and automatically latch each of the three base ring sections 14, 16, 17 together.

A center protruding flat member 50 extends away from a first end of each of the base ring sections 14, 16, 17. Each of the base ring sections 14, 16, 17 includes two opposite side protruding flat members 51a, 51b that extend outward from an opposite second end of each of the base ring sections 14, 16, 17. The first end of each of the base ring sections 14, 16, 17 includes two flat side receiving areas 51c, 51d on opposite sides of the center protruding flat member 50 that are adapted to receive the side protruding flat members 51a, 51b of the adjoining one of the base ring sections 14, 16, 17. Similarly, the second end of each of the base ring sections 14, 16, 17 includes a flat center receiving area 50a that is adapted to receive the center protruding flat member 50 of the adjoining one of the base ring sections 14, 16, 17.

Each of the two flat side receiving areas 51c, 51d and the flat center receiving area 50a, as shown, includes a latch recess 52 that is adapted to receive a corresponding wedge protrusion 53 provided on the center protruding flat member 50 and on the side protruding flat members 51a, 51b when any two of the base ring sections 14, 16, 17 have been properly aligned (i.e., with the protruding flat members 50, 51a, 51b disposed over the corresponding receiving areas 50a, 51c, 51d) and then urged toward each other a sufficient amount. While three latch recesses 52 and three wedge protrusions 53 are shown, only one corresponding pair of each is required to latch, and thereby secure, any two of the base ring sections 14, 16, 17 together.

After each base ring section 14, 16, 17 of the base ring assembly 12 has been properly positioned around the base of the plant the base ring sections 14, 16, 17 are joined together by snapping them together to form the completed (i.e., the assembled and latched) base ring assembly 12. The assembled base ring assembly 12 and the legs 36 are then simultaneously urged into the soil by urging the base ring assembly 12 in a downward direction. If preferred, the leg 36 of each of the base ring sections 14, 16, 17 can first be urged into the soil until properly disposed in the soil and then the base ring sections 14, 16, 17 can be urged (and latched) together. However, it is generally easier to urge the base ring sections 14, 16, 17 together before inserting the legs 36 fully into the soil.

After installation, the base ring assembly 12 surrounds the plant as the plant emerges from soil or from any other root growing medium in which the plant support system 10 is being used. When the plant support system 10 is used in hydroponics applications, a hydroponics growing medium is used as the root growing medium, as is well known in the hydroponics arts, and the base ring assembly 12 again surrounds the plant.

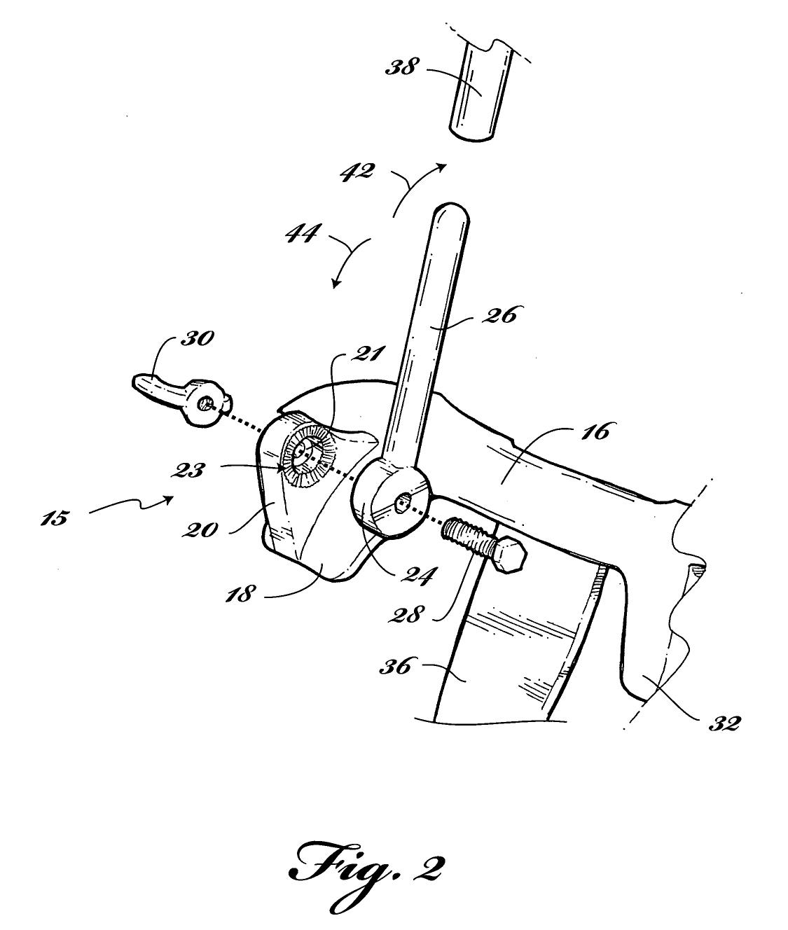

Referring now in particular to FIG. 2, a detailed exploded view of the pivot assembly, identified in general by the reference numeral 15, is shown. For most (circular) versions of the plant support system 10 four of the pivot assemblies 15 are sufficient, although a greater or lesser number are possible. For certain applications, six pivot assemblies 15 are desired. For rectangular or oval versions of the plant support system 10, as many pivot assemblies 15 as is preferred are included.

Each pivot assembly 15 includes a pivot protrusion 20 that is attached to a pivot lip 18 and extends radially away from a center of the base ring assembly 12. The pivot lip 18 is a molded extension that extends in a downward direction and is provided in each of the base ring sections 14, 16, 17 of the base ring assembly 12. A gusset 22 is continually attached to (i.e., molded to) the pivot lip 18 and to the base ring sections 14, 16, 17 and it extends in a generally vertical direction with a slight curvature, thereto, from near a bottom of the pivot lip 18 to a location of the base ring sections 14, 16, 17 that is proximate the inner opening 13. The gusset 22 on the inside of the base ring sections 14, 16, 17 in cooperation with the molded pivot protrusion 20 on the outside of the base ring sections 14, 16, 17 adds considerable mechanical strength and integrity to this part of the base ring sections 14, 16, 17. As is described in greater detail hereinafter, each pivot assembly 15 bears its share of the force and weight of the foliage and fruit that is experienced by the plant support system 10.

The increased mechanical strength that is provided to base ring sections 14, 16, 17 at each pivot assembly 15 provides a very lightweight and compact structure that can be quickly and inexpensively molded (i.e., manufactured) using a preferred type of plastic and which is also very strong.

As many pivot lips 18 and as many pivot protrusions 20 attached thereto can be included with the plant support system 10 as is desired. If desired, such as to reduce the amount of plastic that is used, a modified stiffening lip 32 can be included that is identical in construction to that of the pivot lip 18, however, the stiffening lip 32 does not include the pivot protrusion 20. The stiffening lips 32, if included, are disposed between the pivot lips 18 and the pivot protrusion 20 locations to add additional mechanical strength to the base ring sections 14, 16, 17.

However, it is generally preferred to provide additional pivot lips 18 (with the pivot protrusion 20) to provide the base structures necessary in case additional pivot assemblies 15 are desired. For example, a circular (or any shape) plant support system 10, as sold at retail, may include six pivot lips 18, each with a pivot protrusion 20 attached thereto, but only enough additional component parts (as described in greater detail hereinafter) to complete four (total) pivot assemblies 15 for supporting plant foliage and fruit. That would leave two of the pivot lips 18 and two of the attached pivot protrusions 20, unused.

Later, if additional plant growth warrants additional support by the plant support system 10, the user can purchase separately the additional component parts necessary to complete two pivot assemblies 15 and use those component parts with the two previously unused pivot lips 18 and pivot protrusions 20, thereby being able to increase the carrying capacity of the plant support system 10 by providing two additional pivot assemblies 15.

It is important to note that this allows the user to increase the carrying capacity of the plant support system 10 when desired without having to remove the original plant support system 10 and replace it with a different version. To increase the carrying capacity, the user does not have to remove any portion of the existing plant support system 10. Instead, the user is able to add additional plant supporting structures to the plant support system 10, when desired (providing the originally installed plant support system 10 includes at least one additional pivot lip 18 and at least one additional pivot protrusion 20 that is not initially used as a completed pivot assembly 15.

Referring in particular to FIG. 2 a first side of the pivot protrusion 20 includes a screw opening 21 there-through to allow passage of a screw 28, there-through. The screw 28 is a type of threaded machine screw and it can be formed of metal, plastic or nylon. As described in greater detail hereinafter, the construction of the pivot assembly 15 provides a positive way of securing the component parts thereto in a manner that does not rely excessively on the strength of the screw 28. Therefore, it is possible to use a plastic (or nylon) type of the screw 28, if preferred, instead of a metal one.

Surrounding the screw opening 21 on the first side of the pivot protrusion 20 a pattern of radial raised ridges and adjoining radial lower valleys, identified in general by the reference numeral 23, is provided. The ridges and valleys 23 are disposed as close to each other as preferred to provide finer adjustment of the pivot assembly 15.

Referring also to FIG. 1, the pivot assembly 15 includes a pivot member 24. A first side of the pivot member 24 includes an identical pattern of the radial raised ridges and adjoining radial lower valleys 23 that are able to engage with and cooperate with the ridges and valleys 23 of the pivot protrusion 20 to adjust an angle of a support rod 26 with respect to a vertical longitudinal line that extends upward through a center of the inner opening 13. The support rod 26 is attached (molded) to a top of the pivot member 24.

To adjust the angle of the support rod 26, the user places the screw 28 through a second side of the pivot member 24 and through the screw opening 21 of the pivot protrusion 20. A wing nut 30 (preferably plastic, but any material is possible) engages with the threads of the screw 28 and urges the pivot member 24 adjacent to the pivot protrusion 20.

Prior to a final tightening of the wind nut 30 (while there is still slack) the pivot member 24 is urged into a desired position. It is possible to urge the pivot member 24 into a more vertical orientation by urging a top of the support rod 26 closer toward the vertical longitudinal line, as identified by arrow 42 or to urge the pivot member 24 into a less vertical orientation by urging a top of the support rod 26 further away from the vertical longitudinal line, as identified by arrow 44.

After the pivot member 24 has been urged into the desired position, the wing nut 30 is tightened an additional amount to engage the corresponding ridges and valleys 23 with one another and, thereby, retain the pivot member 24 in the desired position. As engagement of the ridges and valleys 23 provide much of the mechanical strength necessary to retain the pivot member 24 in the desired attitude, considerably less reliance is placed on the screw 28.

In this manner, the plant support system 10 can be quickly adjusted to provide support that corresponds with the shape of the plant foliage and the location of plant fruit.

An important unexpected benefit is also provided by the plant support system 10. As the plant grows it develops additional foliage and fruit. This can change the optimum location (with respect to vertical longitudinal line) for providing support of the foliage and fruit.

The plant support system 10 allows the user to quickly loosen the wing nut 30 and pivot the support rod 26 inward or outward, as desired, and then tighten the wing nut 30 and thereby adjust the support that is provided by the plant support system 10 in response to changes occurring with the foliage and fruit of the plant.

For example, if tomatoes (not shown) disposed away from the vertical longitudinal line are picked (i.e., removed) it may be desirable to urge the support rod 26 inward to provide support to other tomatoes disposed closer toward the vertical longitudinal line. Additionally, the change can be accommodated at any one (or more) of the pivot assemblies 15 without affecting the positioning of any of the remaining pivot assemblies 15. No other type of prior art plant support provides such capability.

A lower rod 38 that extends longitudinally and includes a center opening that has an inside diameter that is larger than an outside diameter of the support rod 26 is urged over the support rod 26 and in a downward direction until a lower portion of the lower rod 38 is disposed over all of the support rod 26. The lower rod 38 is preferably formed of plastic, although any preferred material can be used for the lower rod 38 or for any other component part of the plant support system 10. Accordingly, as the support rod 26 is urged in the direction of arrow 42 or arrow 44 the lower rod 38 is similarly urged.

If desired, any preferred type of plant tie (not shown) is used to secure plant foliage to the lower rod 38.

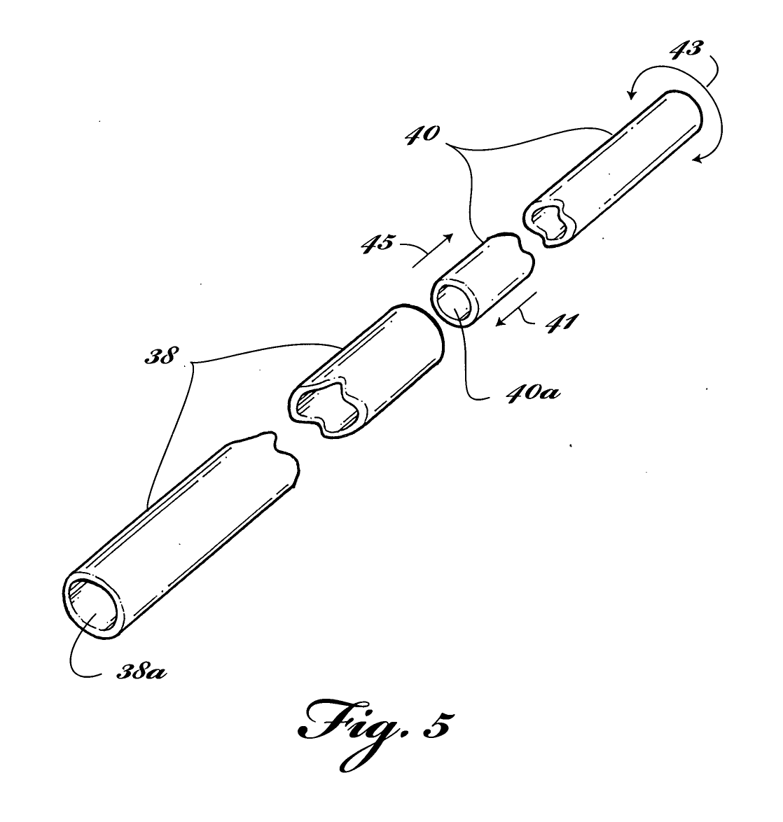

Referring to FIG. 5, a preferred type of the lower rod 38 includes an oval or elliptical opening 38a that extends along the longitudinal length of the lower rod 38. Either the narrowest portion of the opening 38a is large enough to pass over the support rod 26 or, preferably, the support rod 26 is modified to include a similar oval or elliptical shape to correspond and cooperate with that of the lower rod 38.

An upper rod 40 is provided that includes an oval or elliptical (exterior) shape that corresponds with the interior (cross-sectional) shape of the lower rod 38, however, the outside dimensions (i.e., diameter across the oval or elliptical shape) of the upper rod 40 are less than the inside dimensions of the lower rod 38 to permit insertion of the upper rod 40 into the lower rod 38 in the direction as shown by arrow 41, providing the upper rod 40 and the lower rod 38 are oriented with respect to each other so that their oval or elliptical shapes correspond with one-another.

The upper rod 40 can be solid or it can include a smaller oval or elliptical longitudinal opening 40a therein. If the upper rod 40 includes the smaller opening 40a it is possible to include additional smaller identically shaped rods (not shown) and thereby further extend the maximum overall combined length of the upper rod 40 and the lower rod 38 by further use of the method described below.

The upper rod 40 is urged into the lower rod 38 in the direction of arrow 41 until a desired combined overall length of the lower rod 38 and the upper rod 40 has been attained. At that time, the lower rod 38 is grasped by the user and prevented from rotating around a center longitudinal axis thereof while the user grasps and rotates the upper rod 40 in either direction about its center longitudinal axis, as shown by arrow 43. Rotation of the upper rod 40 around its center longitudinal axis with respect to the lower rod 38 causes the exterior of the upper rod 40 to engage with and bind against the interior portions of the opening 38a of the lower rod 38. Eventually, the user is unable to continue rotation of the upper rod 40. At this time, the upper rod 40 will have frictionally engaged with the interior of the opening 38a sufficient to bind the upper rod 40 and the lower rod 38 together. Accordingly, the desired overall combined length of the upper rod 40 and the lower rod 38 are maintained.

As the plant grows it is desirable to extend upward the support that is provided to the plant. The user again grasps both the lower rod 38 and the upper rod 40 and rotates the upper rod 40 in the opposite direction as was used to secure it to the lower rod 38.

Once the upper rod 40 and the lower rod 38 are no longer disposed in binding frictional engagement with each other the upper rod 40 can be urged outward in the direction of arrow 45 to increase the combined overall length of the lower rod 38 and the upper rod 40 or the upper rod 40 can be urged inward in the direction of arrow 41 to decrease the combined overall length of the lower rod 38 and the upper rod 40.

Once the desired combined overall length has been attained, frictional engagement is accomplished as previously described to bind the lower rod 38 and the upper rod 40 and maintain the desired combined overall length. In this manner, the lower rod 38 and the upper rod 40 provide a telescoping assembly that can be quickly adjusted whenever desired to provide any preferred combined overall length as necessary to optimally support the plant.

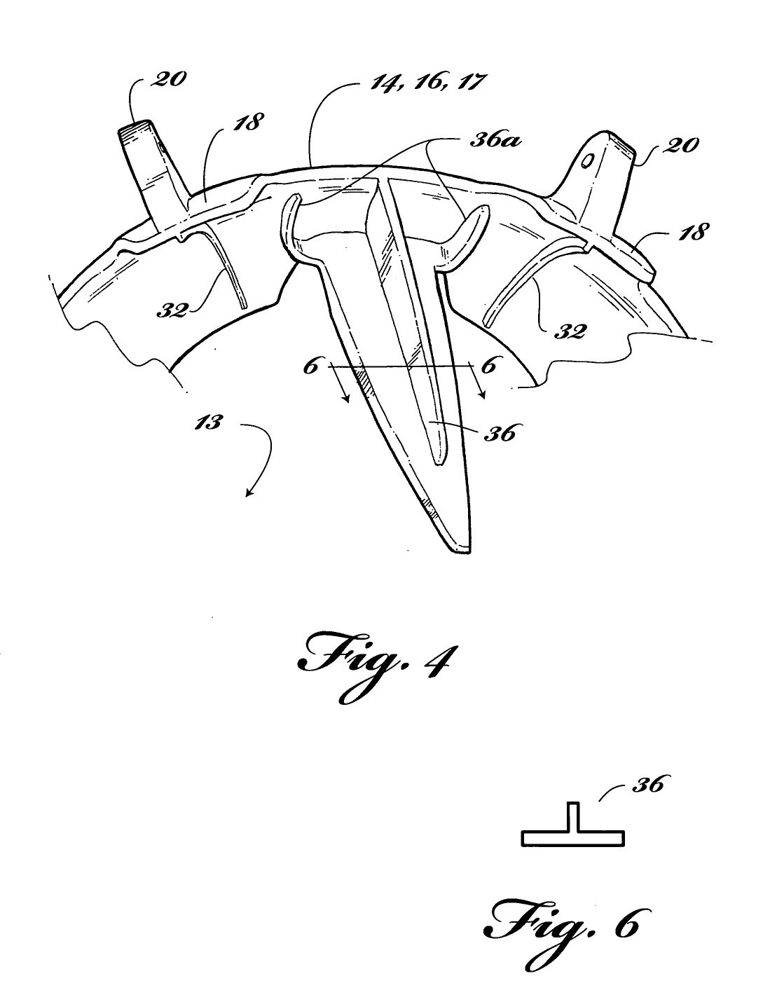

As shown in FIG. 4, a portion of one of the base ring sections 14, 16, 17 is shown that includes one of the legs 36 attached thereto. The leg 36 is disposed between two of the pivot lips 18. If desired, the leg 36 could be disposed between one of the pivot lips 18 and one of the modified stiffening lips 32. The leg 36 includes stiffening members 36a at the base where the leg 36 is attached (molded) to the base ring sections 14, 16, 17. This provides significant mechanical strength to the base ring sections 14, 16, 17 at the base of the leg 36. This additional strength allows the user to force the base ring sections 14, 16, 17 and the leg 36 into the soil without causing damage to the base ring sections 14, 16, 17.

Referring momentarily to FIG. 6, the preferred cross-sectional shape of the leg 36 is shown. This shape provides optimum strength for the leg 36 with a minimal cross-sectional area. The minimal cross-sectional area makes it easy to insert the leg 36 into the soil.

Referring again to FIG. 1, an irrigation line clip 46 is attached to each of the base ring sections 14, 16, 17. The irrigation line clips 46 allow a user to urge an irrigation drip line (not shown) into any of the irrigation line clips 46 to irrigate the plant. The use of drip irrigation is well known. The irrigation line clips 46 allow for convenient installation of the drip line and drip emitters (not shown) without the need for additional drip line retention stakes that could potentially damage the roots of the plant when the stakes are installed. The irrigation line clips 46 also help ensure that the drip emitters will be maintained exactly where desired, over the soil that contains the plant.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

What is claimed is:

1. A plant support system, comprising:
(a) a base ring that includes a predetermined size and an inner opening;
(b) at least one pivot assembly attached to said base ring, wherein said pivot assembly includes a pivot member that is able to pivot about an axis into a more vertical position with respect to a line extending vertically upward through a center of said inner opening or to pivot about said axis into a less vertical position with respect to said line extending vertically upward through said center of said inner opening; and
(c) means for retaining said pivot member in a desired position with respect to said line extending vertically upward through said center of said inner opening.

2. The plant support system of claim 1 wherein said base ring includes a circular shape.

3. The plant support system of claim 1 wherein said base ring includes a base ring assembly.

4. The plant support system of claim 3 wherein said base ring assembly includes at least two base ring sections.

5. The plant support system of claim 4 wherein said base ring assembly include three base ring sections.

6. The plant support system of claim 4 wherein each of said base ring sections includes at least one pivot protrusion attached thereto.

7. The plant support system of claim 6 wherein said pivot protrusion includes a center opening there-through and a plurality of raised ridges and adjacent valleys that extend radially from said center opening, and wherein said pivot member includes an opening there-through and a plurality of raised ridges and adjacent valleys that extend radially from said opening, and wherein when said opening and said center opening are in longitudinal alignment and when said pivot member and said pivot protrusion are retained against each other, said ridges and valleys of said pivot protrusion cooperate with said ridges and valleys of said pivot member to provide said means for retaining said pivot member in said desired position with respect to said line extending vertically upward through said center of said inner opening.

8. The plant support system of claim 7 including a screw that passes through said opening and said center opening and a nut that cooperates with screw threads of said screw.

9. The plant support system of claim 5 wherein each of said base ring sections includes a leg attached thereto.

10. The plant support system of claim 1 wherein said pivot member includes a support rod attached thereto.

11. The plant support system of claim 10 including a lower rod that includes an opening therein that is adapted to fit over said support rod.

12. The plant support system of claim 11 wherein said opening extends along a longitudinal length of said lower rod and wherein said opening includes an oval or an elliptical cross-section.

13. The plant support system of claim 12 including an upper rod, wherein said upper rod includes an oval or elliptical cross-section that corresponds with the cross-sectional shape of said opening of said lower rod, and wherein said upper rod is able to be disposed in said opening of said lower rod and extensible with respect thereto.

14. The plant support system of claim 13 wherein said upper rod is frictionally secured to said lower rod when said upper rod is rotated about a center longitudinal axis thereof with respect to said lower rod.

15. The plant support system of claim 1 including at least one leg attached to said base ring.
